(19) United States
(12) Patent Application Publication
(10) Pub. No.: US 2022/0201980 A1
(43) Pub. Date: Jun. 30, 2022

(54) BAG HOLDER FOR PET WASTE

(71) Applicant: 3SN, LLC, Brighton, MI (US)

(72) Inventor: Stephen James CZARNOWSKI, Brighton, MI (US)

(21) Appl. No.: 17/409,386

(22) Filed: Aug. 23, 2021

Related U.S. Application Data
(60) Provisional application No. 63/131,373, filed on Dec. 29, 2020.

(51) Int. Cl. A01K 23/00; B65F 1/14

(52) U.S. Cl. CPC A01K 23/005; B65F 1/1415

(57) ABSTRACT

A bag holder for pet waste may include a handle portion having a handle and a support extending from the handle; and a rim being pivotally connected to the support and defining an opening to receive a pet waste bag therethrough, wherein the rim is configured to extend between a collapsed position when not in use and an extended position when in use, where the rim is in the collapsed position when the rim is folded towards the support and the rim is in the extended position when the rim is unfolded away from the support.

### CROSS-REFERENCE TO RELATED APPLICATIONS

This application claims benefit to U.S. Provisional Application Ser. No. 63/131,373 filed on Dec. 29, 2020, the disclosure of which is incorporated in its entirety by reference herein.

### TECHNICAL FIELD

Disclosed herein are bag holders for collecting pet waste.

### BACKGROUND

Animal waste, and particularly dog waste, is often cleaned up by the animal owners. Various devices for picking up the waste are on the market and widely used. However, receptacles for receiving the waste may be lacking or cumbersome to use.

### SUMMARY

A bag holder for pet waste may include a handle portion having a handle and a support extending from the handle; and a rim being pivotally connected to the support and defining an opening to receive a pet waste bag therethrough, wherein the rim is configured to extend between a collapsed position when not in use and an extended position when in use, where the rim is in the collapsed position when the rim is folded towards the support and the rim is in the extended position when the rim is unfolded away from the support.

A bag holder for pet waste may include a handle portion having a handle, a support extending from the handle, and a stop disposed at a distal end of the support, and a rim defining an opening to receive a pet waste bag therethrough and pivotally connected to the support, wherein the stop cooperates with the rim to prevent the rim from rotating generally more than 90 degrees about the support.

A bag holder for pet waste may include a handle portion having a handle, a support extending from the handle, and a hook protruding from the support, and a rim defining an opening to receive a pet waste bag therethrough and pivotally connected to the support, wherein the hook protrudes from the support at an acute angle and the hook is configured to receive and support a handle of a pet waste bag.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective view of a bag holder in an expanded state;

FIG. 2 illustrates a perspective view of the bag holder of FIG. 1 with a bag installed;

FIG. 3 illustrates a perspective view of the bag holder of FIG. 1 in a collapsed state;

FIG. 4 illustrates a schematic perspective view of the bag holder of FIG. 1;

FIG. 5 illustrates a schematic perspective view of a rim of the bag holder of FIGS. 4; and

FIG. 6 illustrates a schematic perspective view of a handle portion of the bag holder of FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Family pets, especially dogs, often make waste that must be picked up. Typically, pet owners may pick up dog waste from their yards periodically. In doing this, pet owners may use tools such as a shovel, scooper, claw, etc. Once the waste is picked up by the tool, the waste may then be dropped into a bag. Pet owners may typically use readily available plastic grocery bags and then dispose of the bag. However, while these bags have handles, these bags may not stay open and make it difficult for the owner to drop the waste into.

While the pet waste described in the exemplary example is dog waste, it is noted that the bag holder may be used for other pet wastes and litters. For example, the bag holder may be used to aid in disposal of cat waste, cat litter or the waste or litter of other pets such as rabbits, ferrets, miniature pigs, guinea pigs, rats, or pygmy goats, etc. The bag holder may be used to pick up pet waste in an indoor environment, an outdoor environment, or an indoor-outdoor environment such as a barn. The bag holder may be used to hold non-pet waste, including litter, trash, etc. The bag holder may be used to hold other items such as household items, food items, etc.

Disclosed herein is a bag holder configured to receive a bag and maintain the bag in an open position. The bag holder may hold the bag open, while allowing a user to carry the bag via the handle. The user may then fill the bag with items, including pet waste. The bag holder may include a rim configured to fit the opening of a grocery style plastic bag, where one of the handles of the bag attaches to a hook, and the opposite handle attaches to the front of the rim. When the user is done depositing items into the bag, the bag may be easily removed from the bag holder and placed in the trash. The bag holder may be movable between a collapsed and expanded state and may be configured to fit traditional plastic grocery bags in an effort to re-purpose the bags.

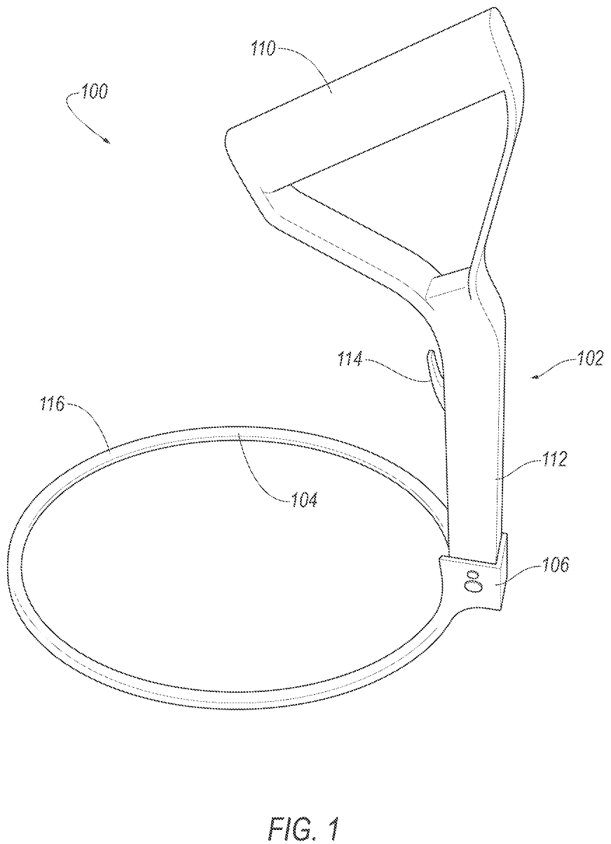

FIG. 1 illustrates a pet waste bag holder in an extended position. The bag holder 100 includes a handle portion 102 and a rim 104. The handle portion 102 may include a handle 110 attached to a support 112. The support may include a hook 114. The handle 110 may be configured to receive a user's hand and may be offset at a predefined angle from the support 112.

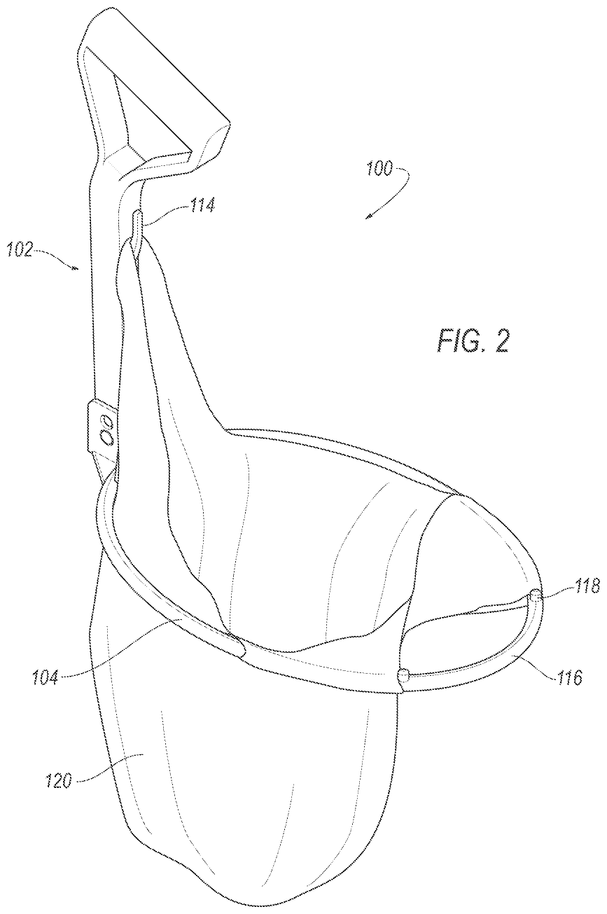

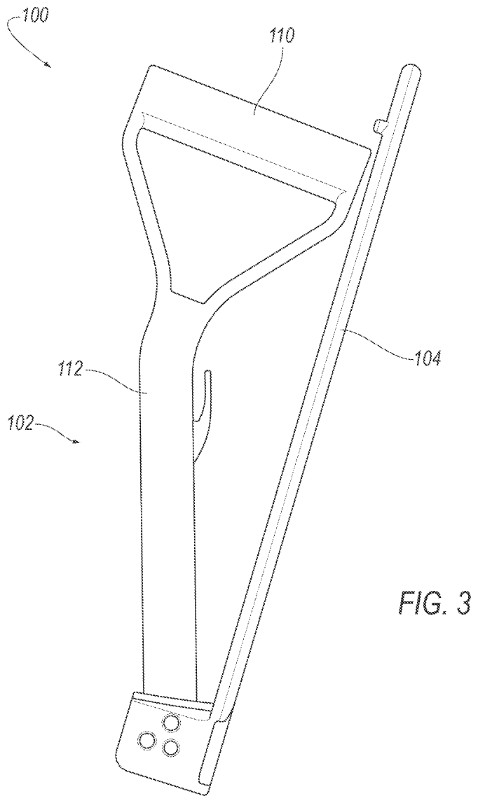

The rim 104 may be hingedly connected to the handle portion 102 at a hinge 106 and movable between an expanded state, as illustrated in FIGS. 1-2, and a collapsed state, as illustrated in FIG. 3. The rim 104 may form an oval shape with its longer radius extending from the handle portion 102.

FIG. 2 illustrates the bag holder in use. The hook may receive a handle of a standard grocery bag. As shown and explained, the rim 104 may be a circular or oblong shape. The rim front 116 is arranged opposite the handle portion 102 and may be configured to receive the other handle of the grocery bag 120. The rim front 116 may have a pair of protrusions 118, each protrusion extending upwards from the rim front 116. The protrusions 118 may be positioned on opposing sides of the rim front 116. To install the bag 120, the bag 120 may be placed in the center of the rim 104. One handle of the bag may extend over the rim front 116 and be stretched around the rim 104 such that the handle portion engages with the rim 104 and the protrusions 118. The protrusions 118 may abut the handle portion 102 to maintain the handle portion on the rim 104. The opposite handle of the bag 120 may then be pulled to hang on the hook 114. When the opposite handle of the bag 120 is pulled to the hook 114, the bag 120 may stretch slightly such that the handle at the rim 104 is pulled further onto the rim 104 and the bag 120 is maintained on the bag holder 100.

FIG. 3 illustrates the bag holder in the collapsed state. The rim 104 rotates with respect to the support 112. The rim 104 may be rotated upward towards the handle portion 102. When the pet waste bag holder is in the collapsed state a front portion of the rim 104 is adjacent a front portion of the handle portion 102 and the rim 104 and the support 112 define an acute angle, the acute angle being less than 45 degrees. The bag holder may be easily stored in the collapsed state when not in use.

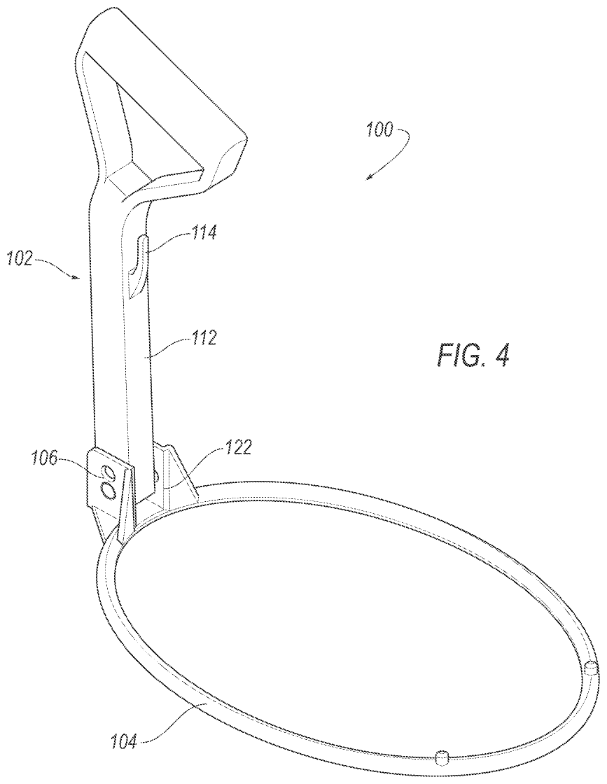

FIG. 4 illustrates a schematic perspective view of the bag holder. The hinge 106 may include at least one attachment mechanism configured to maintain the rim on the support 112. In one example the attachment mechanism is a screw, bolt or pin. In another example the attachment mechanism may include a rivet. An additional exemplary embodiment of the attachment mechanism may include a clip such as a butterfly clip, a spring clip, a v-clip, or a snap clip.

The rim 104 may include a pair of parallel guides 122 configured to receive the support 112 therebetween. The attachment mechanism may then be received by one of the guides 122, then the support 112, and then the other guide 122, allowing the attachment mechanism to extend through the elements and allowing the support 112 and rim 104 to be moveable thereabout. The hinge 106 may allow the rim 104 to radially move with respect to the support 112 and allow the bag holder 100 to collapse and expand.

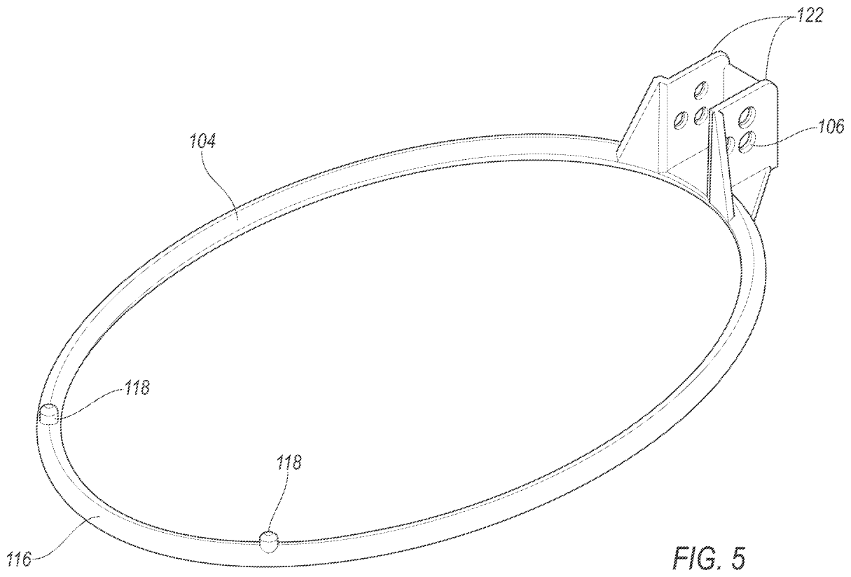

FIG. 5 illustrates a schematic perspective view of the rim of the bag holder 100. The rim 104 may have the shape of a circle or an ellipse. The rim 104 has a rim front 116 opposite the pair of parallel guides 122. At least one protrusion 118 extends upwards from the rim front 116. In one example the rim front 116 has a pair of protrusions 118, each protrusion located on opposing sides of the rim front 116.

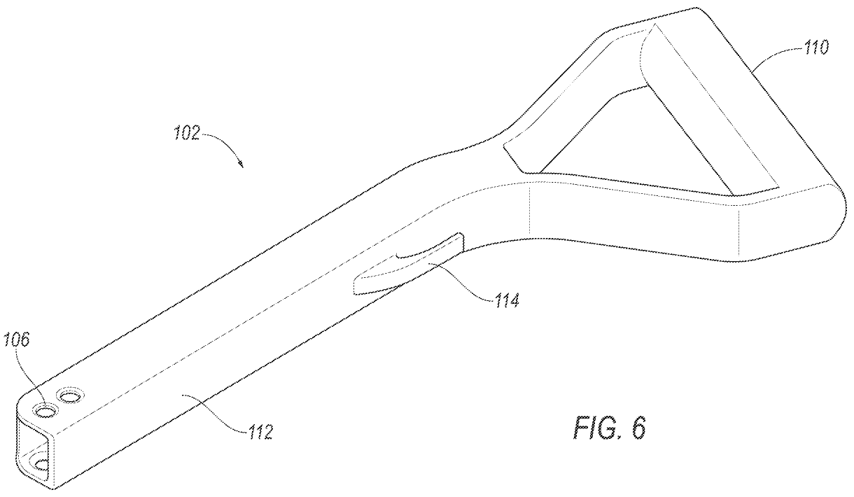

FIG. 6 illustrates a schematic perspective view of the handle portion of the bag holder 100. The handle portion includes the handle portion 102 and the support 112. The support, as mentioned above, may have a hook 114. The hook 114 has a base portion that protrudes at an acute angle with respect to the support 112 and a tip portion that is generally parallel to the support 112. The base portion, the tip portion, and the support define a crevice to receive a pet waste bag handle therein. The tip portion maintains the handle in the crevice and prevents the pet waste bag from slipping off from the bag holder when the bag holder is in use.

The support 112 may have a stop configured to prevent the rim 104 from moving more than 90 degrees about the support 112 in order to maintain the rim 104 at a lateral and level position when in use. The stop may be arranged as a plate extending between the two guides and abut the backside of the support 112 to prevent movement of the rim 104 with respect to the support 112.

While the drawings are not to scale and dimensions may not be limited, an example rim 104 may be approximately 8.5 inches wide and 14 inches long. The dimensions may be configured to receive a standard grocery bag. In other example, special order bags or other commercially available bags may be used, and their dimensions accommodated. The handle portion 102 may be approximately 12 inches long.

The handle 110, as mentioned above, may extend at an angle from the support 112. This may aid in accommodating the weight placed in the bag during use and allow the user to comfortably maintain the rim 104, and thus the bag, level during use. The angle of the handle 110 may counter the weight applied at the rim as pet waste, or other times, are placed therein.

When the user is finished using the bag, or the bag becomes full, the user may easily release the one handle from the hook 114 and bring that handle over to the rim front 116 to release the opposite handle. The user may then have both handles in hand and be able to easily dispose of the bag 120 without coming into contact with the contents of the bag 120. Furthermore, because the bag 120 at least partially covers the rim 104 when the bag 120 is installed, the rim 104 is protected, at least partially, from coming into contact with the waste. Thus, the bag holder 100 does not need to be cleaned after each use, and may be easily storable.

While the bag holder is discussed herein as a holder for bags for receiving pet waste, other application may be appreciated, such as trash pickup, beach cleanup, after party cleanup, picnic cleanup, camp cleanup, tailgating cleanup, craft scrap cleanup, recyclable item pickup, outdoor refuse pickup, small yard waste pickup, etc.

Thus, described herein is a simple, easy to use pet waste bag holder which maintains a bag in an open position to allow a pet owner to place pet waste inside the bag is provided. The bag holder includes a handle portion and a rim. The handle portion includes a handle, a support extending from the handle, and a hook. The support includes at least one opening extending through a proximal end of the support. The rim defines an opening to receive a pet waste bag therethrough. The rim includes at least one receptacle having a receptacle opening configured to align with the opening of the support. The openings form a channel configured to receive a pin and the rim is configured to rotate with respect to the support about the pin where the rim is in a collapsed position when the rim is folded towards the support and the rim is in an extended position when the rim is unfolded away from the support.

A stop is arranged at an end of the support proximal to the rim to engage a portion of the rim and to maintain the rim in a generally lateral position and to prevent over-rotation of the rim with respect to the support when the rim is in the extended position.

The handle is offset at an angle with respect to the support and is configured to receive a user's hand. The angle of the handle is configured to be ergonomically pleasant to the user while maintaining the rim planar to the ground when the pet waste bag holder is in use. The angle of the handle with respect to the support does not exceed 90 degrees and the preferred angle of the handle with respect to the support is between 10 to 45 degrees. The handle and the support may be molded as a unitary part and may be formed from a polymer material such as high-density polyethylene (HDPE).

The hook is disposed on a distal portion of the support and is configured to receive a handle of a pet waste bag. The hook has a base portion that protrudes at an acute angle with respect to the support and a tip portion that is generally parallel to the support. The base portion, the tip portion, and the support define a crevice to receive a pet waste bag handle therein. The tip portion maintains the handle in the crevice and prevents the pet waste bag from slipping off from the bag holder when the bag holder is in use.

In one example, the bag holder is formed from a polymer material such as a high-density polyethylene (HDPE). The bag holder may be formed from other plastic materials such as polyethylene terephthalate (PET), polyvinyl chloride (PVC), polypropylene (PP), or other plastics or combinations thereof. In another example, the bag holder may be made from a malleable metal material such as aluminum or copper or a metal alloy such as brass or other metals or metal alloys or combinations thereof. In another example, the handle may be a different material than the rim. The handle may be plastic and the corresponding rim may be metal. Likewise, the handle may be metal and the corresponding rim may be plastic.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A bag holder for pet waste comprising:
a handle portion having a handle and a support extending from the handle; and
a rim being pivotally connected to the support and defining an opening to receive a pet waste bag therethrough;
wherein the rim is configured to extend between a collapsed position when not in use and an extended position when in use, where the rim is in the collapsed position when the rim is folded towards the support and the rim is in the extended position when the rim is unfolded away from the support

2. The bag holder of claim 1, wherein the rim includes at least one receptacle at a portion of the rim attached to the support, wherein the receptacle is configured to receive the proximal end of the support.

3. The bag holder of claim 2, wherein the support includes at least one opening extending through a proximal end.

4. The bag holder of claim 3, further comprising a clip having one end received in the receptacle opening and an opposing end received in the opening of the support to maintain rim attachment to the support.

5. The bag holder of claim 1, further comprising a stop arranged at an end of the support proximal to the rim to engage a portion of the rim and to maintain the rim in a generally lateral position and to prevent over-rotation of the rim with respect to the support when the rim is in the extended position.

6. The bag holder of claim 5, wherein the stop forms a plate extending outwardly from the support.

7. The bag holder of claim 1, wherein the handle is offset at an angle with respect to the support to receive a user's hand and to maintain the rim planar to a ground surface when the bag holder is in use.

8. The bag holder of claim 1, further comprising a hook disposed on the support to receive a handle of a pet waste bag.

9. The bag holder of claim 8, wherein a front portion of a rim arranged opposite the portion of the rim attached to the support is configured to receive and maintain thereon an opposite handle of a pet waste bag.

10. The bag holder of claim 9, further comprising at least one protrusion extending upwards from the front portion of the rim to receive and maintain an opposite handle of a pet waste bag.

11. The bag holder of claim 1, wherein the rim is sized to receive a standard grocery bag.

12. The bag holder of claim 1, wherein the rim has a shape of a circle or an ellipse.

13. A bag holder for pet waste comprising:
a handle portion having a handle, a support extending from the handle, and a stop disposed at a distal end of the support; and
a rim defining an opening to receive a pet waste bag therethrough and pivotally connected to the support;
wherein the stop cooperates with the rim to prevent the rim from rotating generally more than 90 degrees about the support.

14. A bag holder for pet waste comprising:
a handle portion having a handle, a support extending from the handle, and a hook protruding from the support; and
a rim defining an opening to receive a pet waste bag therethrough and pivotally connected to the support;
wherein the hook protrudes from the support at an acute angle and the hook is configured to receive and support a handle of a pet waste bag.

15. The bag holder of claim 14, wherein a front portion of a rim arranged opposite the portion of the rim attached to the support is configured to receive and maintain thereon an opposite handle of the pet waste bag.

16. The bag holder of claim 14, wherein the support includes at least one opening extending through a proximal end.

17. The bag holder of claim 16, wherein the rim includes at least one receptacle at portion of the rim attached to the support, wherein the receptacle is configured to receive the proximal end of the support.

18. The bag holder of claim 17, wherein the receptable includes at least one receptacle opening configured to align with the opening of the support such that the openings form a channel configured to receive a pin and the rim is configured to rotate with respect to the support about the pin.

19. The bag holder of claim 17, further comprising a clip having one end received in the receptacle opening and an opposing end received in the opening of the support to maintain the rim attachment to the support.

20. The bag holder of claim 19, wherein the clip is a butterfly clip, a spring clip, a v-clip, or a snap clip.
